(19) United States
(12) Patent Application Publication
(10) Pub. No.: US 2008/0165470 A1
(43) Pub. Date: Jul. 10, 2008

(54) Functional Carbon Material and Method of Producing the Same

(75) Inventor: Chul Wan Park, Seoul (KR)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: KOREA ELECTRONICS TECHNOLOGY INSTITUTE, Gyeonggi-do (KR)

(21) Appl. No.: 11/971,567

(22) Filed: Jan. 9, 2008

(30) Foreign Application Priority Data
Jan. 9, 2007 (KR) 10-2007-0002377

(51) Int. Cl. H01G 9/00; C09C 1/44; C01B 31/08

(52) U.S. Cl. 361/502; 423/460; 423/445 R

(57) ABSTRACT

An object of the present invention is to provide carbon material with a catalytic precursor, which can have improved conductivity, specific surface area and capacitance per volume by applying another carbon matter of high conductivity to a surface of activated carbons, and method of producing the same.

The functional carbon material in accordance with the present invention comprises activated carbons made using granulated composites of carbon and alkali compounds as a precursor; and carbon matter of a different type from the activated carbon, which is formed on the surface of the activated carbon.

The method of producing carbon material using a catalytic precursor in accordance with the present invention comprises the steps of: mixing the catalytic precursor with activated carbon; reducing the catalytic precursor; and forming carbon matter of a different type from the activated carbon, using the catalytic precursor.

### BACKGROUND OF THE INVENTION

1. Field of the Invention

The present invention relates to functional carbon material which can be used in electric double layer capacitor electrodes and method of producing the same. More specifically, the present invention relates to functional carbon material which can increase conductivity and capacitance by applying, to activated carbon formed using a carbon/alkali compound precursor, carbon matter of a different type from the activated carbon, and method of producing the same.

2. Background of the Related Art

Any discussion of the prior art throughout the specification should in no way be considered as an admission that such prior art is widely known or forms part of common general knowledge in this field.

Activated carbons refer to black carbon particles which are made from flammable material through a carbonization at about 500° C. and an activation at about 900° C. In a broad sense, activated carbon means carbon which an activator has been added to for an improved function and thus can cause chemical reactions or crystal lattices more easily.

Activated carbons are commonly used for various purposes in the many fields including food industry, chemical industry, medical and pharmaceutical industry, and petrochemical industry. Activated carbons for liquid phase-objects are used for manufacturing sugar, starch syrup, flavoring matters or liquor, dry cleaning, recovering gold, and treating clean water and wastewater. Activated carbons for gas phase-objects are used for cigarette filters, gas masks, air purifiers, car canisters, etc. Activated carbons for gas phase-objects are also used for removing poisonous gas, retrieving organic solvents (volatile organic compounds (VOCs)), adsorbing radioactive materials. Besides, activated carbons are used for analyzing medical supplies and instruments, due to their adsorptive properties. And there is an increasing inclination to use activated carbons as excellent adsorbents.

Recently, activated carbons have been noted as matter of electric double layer capacitor electrodes in the field of electronics, especially in batteries of back-up power source, assistant power source, etc. An electric double layer capacitor in which activated carbons are used as a polarized electrode has an excellent capacitance. So, there have been increasing demands for such electric double layer capacitors, as many developments have been made in the field of electronics. In addition, as conventional memory back-up power sources have been made smaller, such electric double layer capacitors are prospective to be used for assistant power sources.

An electric double layer capacitor electrode is required to have a long longevity, perform rapid charging and discharging in a short time, and have durability to excessive charging. And also, it must have an ability to endure at the harsh temperatures, so as to be used in the polar regions or the equatorial regions, and so on.

Especially, capability of a capacitor depends on capacitance per unit volume. In this regard, conventional activated carbons have a low capacitance because of their small specific surface area.

### SUMMARY OF THE INVENTION

Accordingly, the present invention is directed to functional carbon material for electric double layer capacitor electrodes and method of producing the same that substantially obviates one or more problems due to limitations and disadvantages of the related art.

An object of the present invention is to provide functional carbon material for electric double layer capacitor electrodes, which can have improved conductivity, specific surface area and capacitance per volume by applying, to a surface of activated carbon, carbon matter of a different type from the activated carbon and of high conductivity, and method of producing the same.

To accomplish the above objects, according to one aspect of the present invention, there is provided functional carbon material comprising: activated carbon, which is made using granulated composites of carbon and alkali compounds as a precursor; and carbon matter of a different type from the activated carbon, which is formed on the surface of the activated carbon.

And there is provided a method of producing functional carbon material using a catalytic precursor, the method comprising the steps of: mixing the catalytic precursor with activated carbon; reducing the catalytic precursor; and forming carbon matter of a different type from the activated carbon, using the catalytic precursor.

It is to be understood that both the foregoing general description and the following detailed description of the present invention are exemplary and explanatory and are intended to provide further explanation of the invention as claimed.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 is a flow chart which shows a process of producing functional carbon material using a catalytic precursor, in accordance with the present invention;

FIG. 2 shows activated carbon in which pores are formed, according to the present invention;

FIG. 3 shows activated carbon to which a catalytic precursor is applied, according to the present invention;

FIG. 4 shows activated carbon with a reduced catalytic precursor, according to the present invention;

FIG. 5 shows carbon matter of a type different from the activated carbon, which is grown from a catalytic precursor, according to the present invention;

FIG. 6 is a flow chart which shows a process of producing activated carbons, according to the present invention; and

FIG. 7 and FIG. 8 are scanning electron microscopic (SEM) images of activated carbons with carbon matter of a different type from the activated carbon, according to the present invention.

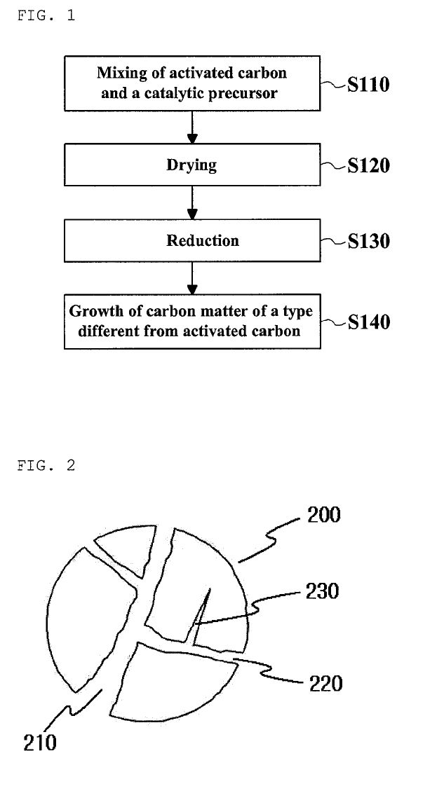

### DETAILED DESCRIPTION OF THE PREFERRED EMBODIMENT

The present invention will now be described more fully with reference to the accompanying drawings, in which exemplary embodiments of the invention are shown. The invention may, however, be embodied in many different forms and should not be construed as being limited to the embodiments set force herein, rather, these embodiments are provided so that this disclosure will be thorough and complete, and will fully convey the concept of the invention to those skilled in the art.

FIG. 1 is a flow chart which shows a process of producing functional carbon material using a catalytic precursor, in accordance with the present invention. First of all, a catalytic precursor is mixed with activated carbons in a solution in S110.

[Production of Activated Carbons]

Activated carbon can be purchased or produced to be used for producing the functional carbon material according to the present invention. Activated carbons for the present invention can be produced in many ways, for example, using water vapor or alkali compounds, or by an electrical process. One of the methods of producing activated carbons using alkali compounds is described below, and FIG. 6 is a flow chart which shows a process of producing activated carbons, according to the present invention.

In producing the activated carbons according to the present invention, carbonic material is mixed with alkali metal compounds in S610. The carbonic material used for the present invention is particles with a diameter of 10 μm or less than 10 μm. The carbonic material has not been activated or has already been liquefied at least one time in an activation process, and it has a carbon content of 75%˜97% in weight. The alkali compounds include inorganic compounds of alkaline metals, such as KOH, NaOH, LiOH, K₂CO₃, Na₂CO₃, and LiCO₃, or inorganic compounds of alkaline earth metals, or organic compounds including K, Na or Li, or metal complex thereof. It is preferred to use sodium hydroxide and/or potassium hydroxide for obtaining carbonic material with good capacitance. And it is preferred that a weight ratio of alkaline metal compounds to carbonic material is about 1˜3.

After that, the mixture obtained in S610 is granulated in S620. An atomizer or an ultrasonic nebulizer, etc. can be used for a spray method. And as a spray/dry method, a usual fluid-bed spray granulation is used, in which the mixed solution is sprayed to a fluid bed and simultaneously water is vaporized from the fluid bed. At this time, a nozzle, preferably a centrifugal atomizer, is used for atomizing the mixture in dry air current which is injected centrifugally after being heated, preferably to 140˜190° C. The amount of the supplied mixture is changed according to the amount of the injected hot air, so that the mixture can be dried to have a water content of about 0.3˜1 weight %. In the case of an ultrasonic nebulizer, the mixture is crystallized to be stabilized in air. Carrier gas puts droplets thus generated into a dryer, in which water is evaporated from the droplets and accordingly the droplets are converted to solid particles through granulation. Resultingly, the minute granulated pulverulent bodies makes a reduction in contacts with an activation apparatus and makes gases such as water vapor or CO₂ go out easily.

The granulated mixture obtained in S620 is gone through a first activation process in a solid state, to produce a granular first activated complex, in S630. According to the present invention, it is preferred that the first activation is processed to meet the requirements shown in the following formula, which represents a relation of a pressure and a rate of increasing temperature. Under this condition, the mixture can maintain its solid state during the first activation.

P×v<15[Torr·° C./min] [Formula]1

Here, P is a pressure applied in a first activation (unit: Torr) and v is a rate of increasing temperature applied in a first activation (unit: ° C./min)

If the first activation process is performed according to the Formula 1, raw material in the first activated complex can be kept in a solid state during the first activation process. Because, under this condition, water contained in the raw material in the first activated complex can be evaporated to lower a water content of the raw material, with the raw material kept in a solid state. The rate of increasing temperature is not limited to a uniform rate, and in so far as the conditions of the Formula 1 are satisfied, a pressure or a rate of increasing temperature can be freely changed. The first activation process is preferably performed under a pressure of 0.01˜10 Torr, at a temperature of 200° C.˜400° C.

The granulated mixture has the advantage that water vapor can go off easily through a lot of micropores 230, mesopores 220 and macropores 210, which are made on the surface or inside of the granulated mixture.

Then, activated carbons are produced by performing a second activation of the granulated mixture, in S640. The granulated mixture used in the present invention can have a reduced contact area to an activation apparatus and thus diminish corrosion of the apparatus caused by alkaline metal hydroxides. Also, it can facilitate removal of CO₂ gas and accordingly decrease the amount of used chemicals. In this way, the process can be performed with high stability. This makes a reaction proceed in a condition of a low vacuum. Generally, the second activation process can be performed in the environment of inert gas such as nitrogen, argon, etc.

After the second activation process is completed, the resulting products, activated carbons, are cooled. At this time, it is preferred that cooling is performed using air current of inert gas such as nitrogen, argon, etc., so as to inhibit combustion of the resulting products. Then, the resulting products are washed with water, alcohol, acid or base in a standard way to remove alkaline metals therefrom, and then dried to obtain activated carbons. As described above, both the carbonic material and alkaline metal mixture are kept in a solid state during the process. The mixture is processed in a solid process during the first and second activation processes, thereby remarkably reducing corrosion by oxidation

[Mixing Activated Carbons with a Catalytic Precursor]

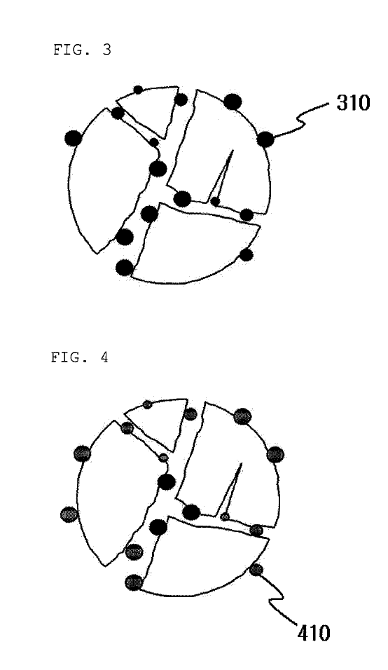

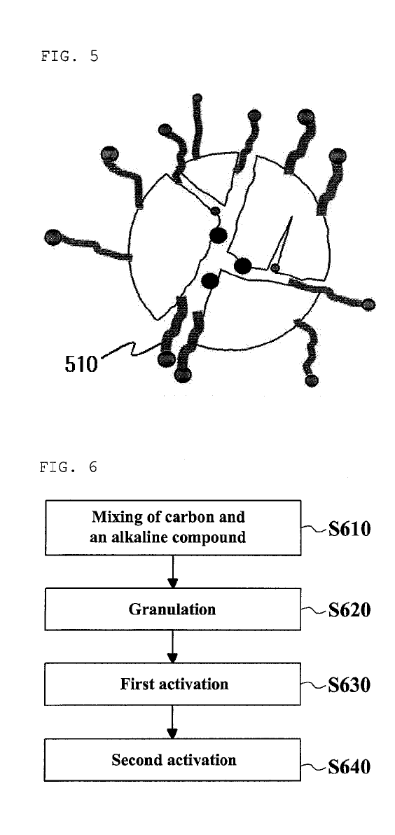

As shown in FIGS. 1 and 3, a catalytic precursor 310 is mixed with activated carbons with many micropores (<2 nm), mesopores (2˜50 nm) and macropores (>50 nm). At this time, a mixer can be used to mix them better in a solution like ethanol. The catalytic precursor in accordance with the present invention can be Ni, Fe, or Co, or their compounds. When mixing is completed, the catalytic precursors 310 attach to the surface of the activated carbon and the pores generated inside the activated carbon.

[Drying]

As the next step shown in S120, the activated carbons with the catalytic precursors are dried in an oven, at a temperature of 100° C. to 150° C., for 24 hours.

[Reduction]

When drying is completed, the activated carbons with the catalytic precursors go through a reduction process in a hydrogen environment in S130, to form etched catalytic precursors 410.

[Growth of Carbon Matter of a Type Different from the Activated Carbon]

Carbon matter of a type different from the activated carbon 510 is grown, using the reduced catalytic precursors. For growing carbon matter of a type different from the activated carbon, one of an electric discharge method, a laser disposition method, a pyrolysis deposition method, a thermal chemical vapor deposition (CVD) method and a plasma enhanced chemical vapor deposition (PECVD) method can be used. And it is preferred that a chemical vapor deposition (CVD) method is used for a mass production.

The carbon matter of a type different from the activated carbon in accordance with the present invention is a carbon nanotube or a carbon nano fiber. In the case of using a chemical vapor deposition method, carbon-containing gas can be used as source gas within the temperature range of 400° C.˜800° C.

Source gas in accordance with the present invention can be CO or ethylene.

If carbon matter of a type different from the activated carbon has grown, the activated carbons are slowly cooled in the environment of inert gas to yield activated carbon with carbon matter of a type different from the activated carbon.

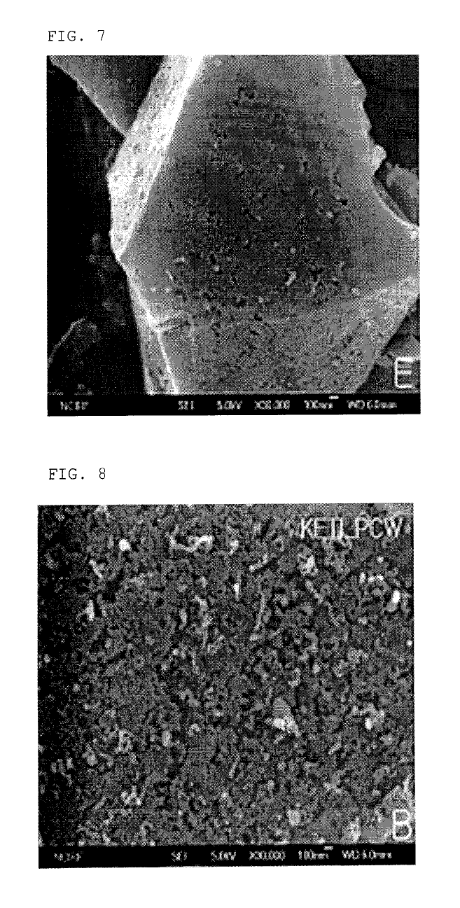

FIG. 7 and FIG. 8 are scanning electron microscopic (SEM) images of activated carbons with carbon matter of a different type from the activated carbon, according to the present invention. In the figures, it is shown that carbon matters of a type different from activated carbon have grown in the minute pores formed on the surface of the activated carbon.

The functional carbon material and a method of producing the same in accordance with the present invention have the advantage of reducing contact resistance between the activated carbons and thus improving current density and capacitance.

What is claimed is:

1. Functional carbon material, comprising:
activated carbon, which is made using granulated composites of carbon and alkali compounds as a precursor; and
carbon matter of a different type from the activated carbon, which is formed on the surface of the activated carbon.

2. The functional carbon material of claim 1, wherein the carbon matter of a different type from the activated carbon is a carbon nano tube or a carbon fiber.

3. The functional carbon material of claim 2, the catalytic precursor is reduced in a hydrogen environment.

4. The functional carbon material of claim 3, the carbon matter of a different type from the activated carbon is grown in an environment of carbon oxides or ethylene gas.

5. The carbon functional material of claim 4, the carbon matter of a different type from the activated carbon is grown using a chemical vapor deposition method.

6. A method of producing functional carbon material using a catalytic precursor, the method comprising the steps of:
mixing the catalytic precursor with activated carbon;
reducing the catalytic precursor; and
forming carbon matter of a different type from the activated carbon, using the catalytic precursor.

7. The method of producing functional carbon material using a catalytic precursor as defined in claim 6, wherein the activated carbons are made using granulated composites of carbon and alkali compounds as the precursor.

8. An electric double layer capacitor electrode which uses the functional carbon material of claim 1.
